(19) United States
(12) Patent Application Publication
(10) Pub. No.: US 2024/0056877 A1
(43) Pub. Date: Feb. 15, 2024

(54) METHOD AND DEVICE FOR SUPPORTING DETERMINISTIC NETWORKING IN WIRELESS COMMUNICATION SYSTEM

(71) Applicant: SAMSUNG ELECTRONICS CO., LTD., Suwon-si (KR)

(72) Inventor: Sangjun MOON, Suwon-si (KR)

(21) Appl. No.: 18/447,215

(22) Filed: Aug. 9, 2023

(30) Foreign Application Priority Data
Aug. 9, 2022 (KR) 10-2022-0099275

(51) Int. Cl. H04W 28/02

(52) U.S. Cl. CPC H04W 28/0268; H04W 92/02

(57) ABSTRACT

A method and device for stably supporting the DetNet in a wireless communication system are provided. A method performed by a network entity supporting deterministic networking (DetNet) in a wireless communication system is provided, the method comprises receiving, from a Detnet controller of a deterministic network, configuration information including requirements in the deterministic network; identifying, based on the configuration information, a protocol data unit (PDU) session of associated with an internet protocol (IP) address of a user equipment (UE): and transmitting, to a policy control function (PCF), quality of service (QoS) parameters obtained based on the requirements in the configuration information, the QoS parameters being used for a policy update to be applied for the PDU session.

### CROSS-REFERENCE TO RELATED APPLICATION

This application is based on and claims priority under 35 U.S.C. § 119 to Korean Patent Application No. 10-2022-0099275, which was filed in the Korean Intellectual Property Office on Aug. 9, 2022, the entire disclosure of which is incorporated herein by reference.

### BACKGROUND

### 1. Field

The disclosure relates to a method and device for providing a delay guarantee service in a wireless communication system.

### 2. Description of Related Art

5^{th} generation (5G) mobile communication technology defines a wide frequency band to enable fast transmission speed and new services and may be implemented in frequencies below 6 GHz (“sub 6 GHz”), such as 3.5 GHz, as well as in ultra-high frequency bands (“above 6 GHz”), such as 28 GHz and 39 GHz called millimeter wave (mmWave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the voice over new radio (VoNR), new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step RACH for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

### SUMMARY

When interworking with IP-based wide-area delay deterministic networking (DetNet) technology to provide a delay guarantee service in a 5G system, the DetNet provides end-to-end (E2E) requirements. However, since the 5G system provides an inter-link QoS guarantee function, it is required to convert the requirements of DetNet into the corresponding per-link requirements in the 5G system.

The present disclosure provides a method and device for stably supporting the DetNet in a wireless communication system.

The present disclosure also provides a method and device for converting QoS-related end-to-end (E2E) requirements into QoS-related per-link requirements for DetNet interworking in a wireless communication system.

The present disclosure also provides a method and device for stably supporting the DetNet in a wireless communication system that provides a delay guarantee service.

In accordance with an aspect of the disclosure, a method performed by a network entity supporting deterministic networking (Detnet) in a wireless communication system is provided, the method comprises receiving, from a Detnet controller of a deterministic network, configuration information including requirements in the deterministic network; identifying, based on the configuration information, a protocol data unit (PDU) session of associated with an internet protocol (IP) address of a user equipment (UE); and transmitting, to a policy control function (PCF), quality of service (QoS) parameters obtained based on the requirements in the configuration information, the QoS parameters being used for a policy update to be applied for the PDU session.

In accordance with another aspect of the disclosure, a network entity supporting deterministic networking (Detnet) in a wireless communication system is provided, the network entity comprises a transceiver, and a processor configured to receive, via the transceiver from a DetNet controller of a deterministic network, configuration information including requirements in the deterministic network, identify, based on the configuration information, a protocol data unit (PDU) session of associated with an internet protocol (IP) address of a user equipment (UE), and transmit, to a policy control function (PCF) via the transceiver, a message including quality of service (QoS) parameters obtained based on the requirements in the configuration information, the QoS parameters being used for a policy update to be applied for the PDU session.

In accordance with another aspect of the disclosure, a deterministic networking (Detnet) controller of a deterministic network communicating with a network entity supporting DetNet in a wireless communication system is provided, the Detnet controller comprises a transceiver, and a processor configured to transmit, to the network entity via the transceiver, configuration information including quality of requirements in the deterministic network, and receive, via the transceiver from the network entity, a response message in response to transmission of the configuration information, wherein a protocol data unit (PDU) session of associated with an internet protocol (IP) address of a user equipment (UE) is identified based on the configuration information, and wherein quality of service (QoS) parameters based on the requirements in the configuration information are used for a policy update to be applied for the PDU session.

In accordance with another aspect of the disclosure, a policy control function (PCF) in a wireless communication system is provided, the PCF comprises a transceiver, and a processor configured to receive, from a network entity supporting deterministic networking (DetNet), quality of service (QoS) parameters corresponding to requirements in a deterministic network, and update, based on the QoS parameters, a policy to be applied for a protocol data unit (PDU) session of associated with an internet protocol (IP) address of a user equipment (UE).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 illustrates an information flow when a 5G system interworks with a TSN based on Ethernet according to an embodiment of the present disclosure;

FIG. 2 illustrates an information flow when a 5G system interworks with a DetNet based on an IP network according to an embodiment of the present disclosure;

FIG. 3 illustrates requirements upon DetNet interworking when a DetNet provides QoS-related E2E requirements and a 5G system provides QoS-related per-link requirements according to an embodiment of the present disclosure;

FIG. 4 illustrates a DetNet AF (or TSCTSF/NEF) of a 5G system derives per-link QoS requirements for a 5G system from E2E requirements of a DetNet according to an embodiment of the present disclosure;

FIG. 5 illustrates a network procedure to which the method of FIG. 4 is applied when a 5G system interworks with a DetNet according to an embodiment of the present disclosure; and

FIG. 6 illustrates a configuration of a network entity in a wireless communication system according to an embodiment of the present disclosure.

### DETAILED DESCRIPTION

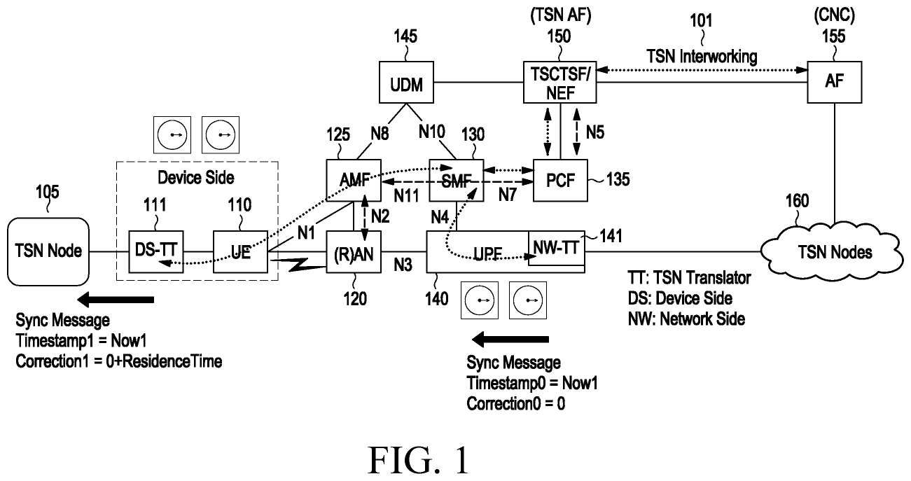

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure is described below with reference to the accompanying drawings. When determined to make the subject matter of the present disclosure unclear, the detailed of the known functions or configurations may be skipped. The terms as used herein are defined considering the functions in the present disclosure and may be replaced with other terms according to the intention or practice of the user or operator. Therefore, the terms should be defined based on the overall disclosure.

Advantages and features of the present disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, a “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments, a “.unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In the disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (IAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

For ease of description, the terms and names defined in the latest 3rd generation partnership project 5G and NR standards among the current communication standards are used herein. However, the disclosure is not limited by such terms and names and may be likewise applicable to wireless communication networks conforming to other standards. In particular, the disclosure may be applied to 3GPP GS/NR (5th generation mobile communication standards).

In the disclosure, the network technology may refer to the standards (e.g., TS 23.501, TS 23.502, TS 23.503, etc.) defined by the international telecommunication union (ITU) or 3GPP, and the components included in the network architecture described below may mean physical entities or may mean software that performs an individual function or hardware combined with software.

The 3GPP standard standardized the 5G network system architecture and procedures. A mobile network operator may provide various services in a 5G network. To provide each service, the mobile network operator needs to meet different service requirements (e.g., delay, communication range, data rate, bandwidth, reliability, etc.) for each service. To that end, the 5G system may support network slicing (or may be referred to as the network slice), and traffic for different network slices may be handled by different PDU sessions. The PDU session may mean an association between a data network providing a PDU connection service and a UE. The network slice may be understood as technology for logically configuring a network with a set of network functions (NF) to support various services with different characteristics, such as broadband communication services, massive IoT, V2X, or other mission critical services, and separating different network slices. Therefore, even when a communication failure occurs in one network slice, communication in other network slices is not affected, so that it is possible to provide a stable communication service. To that end, the mobile network operator may constitute the network slice and may allocate network resources suitable for a specific service for each network slice or for each set of network slices. The network resource may mean a network function (NF) or logical resource provided by the NF or radio resource allocation of a base station. For example, the mobile network operator may configure network slice A for providing a mobile broadband service, network slice B for providing a vehicle communication service, and network slice C for providing an IoT service. In other words, the 5G system may efficiently provide a corresponding service to a UE through a specialized network slice suited for the characteristics of each service.

In the drawings, reference numerals shown as N1, N2, N3, . . . , Nxxx indicate known interfaces between the network functions in the 5G system. The 3GPP system defines a conceptual link connecting NFs in the 5G system as a reference point. Reference points included in the 5G system structure are described as an example below.
N1: Reference point between the UE and the access and mobility management function (AMF);
N2: Reference point between the base station (R)AN and the AMF,
N3: Reference point between the base station ((R)AN) and the user plane function (UPF);
N4: Reference point between the session management function (SMF) and the UPF;
N5: Reference point between the policy control function (PCF) and the application function (AF);
N6: Reference point between the UPF and the data network (DN);
N7: Reference point between SMF and PCF;
N8: Reference point between the user data management (UDM) and the AMF;
N9: Reference point between two core UPFs;
N10: Reference point between UDM and SMF; and/or
N11: Reference point between AMF and SMF.

The 5G system may include a 5G core network (5GC), a base station, and a user equipment (UE). The 5GC may include an AMF that manages mobility of the UE, an SMF that manages the session, a UPF that is connected to the data network (DN) and plays a role to transfer data, a network exposure function (NEF) that transfers or receives the event occurring in the 5G system and the capability to be supported to the outside, a PCF that provides the policy control function of the network operator, and a UDM that provides the function of managing data such as subscriber data and policy control data, and the AF that provides the application service may communicate with the 5GC. The AMF is a network entity for managing access and mobility of the UE. The AMF may perform such network functions as registration of the UE, connection, reachability, mobility management, access identification, authentication, and mobility event generation. The SMF may perform a management function for a protocol data unit (PDU) session of the UE.

For example, the SMF may perform such network functions as session management functions of establishing, modifying, or releasing a session and maintaining a tunnel between the UPF and the base station, the functions of allocating and managing an Internet protocol (IP) address of the UE, selection and control of the user plane. The UPF may perform a data processing function of transferring data transmitted by the UE to the DN, which is an external network, or transferring data received from the DN to the UE. Further, the UPF may perform network functions, such as acting as an anchor between radio access technologies (RATs), providing connection with PDU sessions and the AF, packet routing and forwarding, packet inspection, application of user plane policy, creating a traffic usage report, or buffering. The PCF may manage operator policy information for providing the service in the 5G system, and the UDM may perform functions such as generating authentication information for 3GPP security, managing the list of NFs supporting the UE, and managing subscription information.

The unified data repository (UDR) may perform the functions of storing and providing subscription information managed by the UDM, structured data for exposure, and application data related to NEF or service. Meanwhile, in a UE registration procedure, the UE may transmit, to the AMF, identification information about network slices to be requested (requested single-network slice selection assistance information (S-NSSAIs)), and the AMF may provide the UE with information about a network slice available to the UE (allowed NSSAI) in consideration of the requested S-NSSAIs, subscriber information, and the like. In order to transmit and receive data to and from a specific data network (DN) through allowed slices (allowed NSSAIs), the UE may select one of the allowed slices, request the data network name (DNN) for the network slice selected from among the allowed network slices to generate a PDU session, and transmit and receive data through the generated PDU session. In the embodiments of FIGS. 1 to 5, basic functions of network entities such as the NEF, the UDM 145, the UPF 140, the PCF 135, the SMF 130, the AMF 125, and the (R)AN 120 are the same as those described above.

FIG. 1 illustrates an information flow when a 5G system interworks with a time sensitive network (TSN) based on Ethernet according to an embodiment of the present disclosure.

Referring to FIG. 1, a centralized network configuration (CNC) server 155 (or AF) connected to a TSN node(s) 160 in an external network of a 5G system may transfer a quality of service (QoS)-related requirement of a TSN for TSN interworking to a TSN AF 150 (or TSCTSF/NEF) of the 5G system, and the TSN AF 150 may configure necessary information in a TSN converter (device side TSN translator (DS-TT)) 111 on the UE 110 side and a TSN converter (network side TSN translator (NW-TT)) 141 on the network side according to the QoS-related requirement transferred from the CNC server 155. Conversely, the TSN AF 150 may collect the 5G system information from the DS-TT 111 and the NW-TT 141 and transfer the collected information to the CNC server 155.

For example, when the 5G system provides time synchronization to the UE 110, the TSN AF 150 in the 5G system may configure the NW-TT 141 and the DS-TT 111 based on the information provided from the CNC server 155, convert the sync message provided from the external network based on the internal time of the 5G system and transfer the sync message, and when the sync message is again transferred from the 5G system to the external network, the 5G system may again convert the sync message based on the external time of the external TSN node. In the example of FIG. 1, the sync message converted by the DS-TT 111 may be transferred to a device (TSN node) tethered to the UE 110 through, e.g., WI-FI. In the example of FIG. 1, when using the AF connected to the TSN node(s) 160 in the external network instead of the CNC server 155 for TSN interworking, the 5G system may receive a requirement from the AF connected to the TSN node(s) 160 using the time sensitive communications and time synchronization function (or NEF) instead of the TSN AF 150, and the TSCTSF may configure the DS-TT 111 and the NW-TT 141 according to the requirement.

Conversely, the TSCTSF 150 may collect the 5G system information from the DS-TT 111 and the NW-TT 141 and transfer the collected information to the AF connected to the TSN node(s) 160. Further, the NEF may be required together with the TSCTSF depending on whether the AF belongs to the 5G system. For example, the NEF along with the TSCTSF may be needed when the AF does not belong to the 5G system. FIG. 1 illustrates operations when performing TSN interworking to transfer the requirement of the TSN to the 5G system based on Ethernet which transfers information via hop-by-hop and NFs participating in the operations. For example, when the TSN AF 150 (or TSCTSF/NEF) receiving the requirement from the CNC server 155 (or AF) sets the 5G system to be the time synchronization source, the NW-TT 141 creates a sync message with the current time recorded in the timestamp field and the correction field set to 0 and transmits the sync message to the DS-TT 111. The DS-TTT 111 adds the residence time, which is the time when the DS-TTT 111 stays in the 5G system, to the correction field, and transmit the sync message to the next TSN node 105.

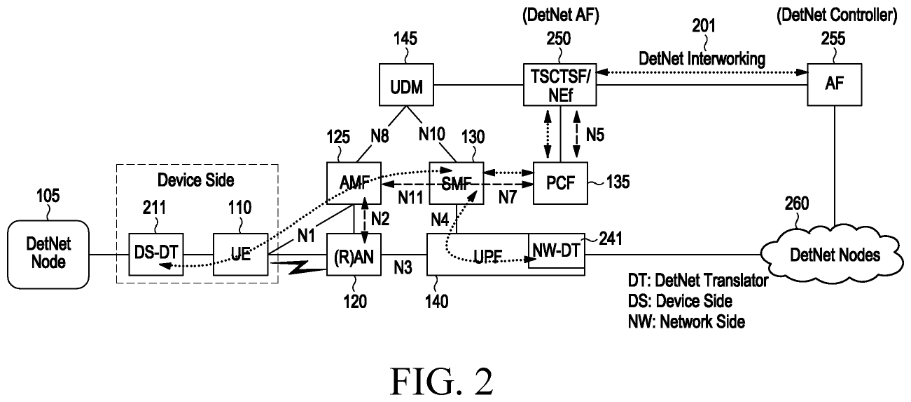

FIG. 2 illustrates an information flow when a 5G system interworks with a DetNet based on an IP network according to an embodiment of the present disclosure. DetNet is a delay-deterministic networking technology that guarantees lossless delivery of data flows and end-to-end (E2E) (ultra) low delay through explicit path configuration and resource reservation. Compared with the Ethernet-based TSN interworking in which information is processed by hop-by-hop in FIG. 1, the example of FIG. 2 may process E2E DetNet interworking. Further, the example of FIG. 2 may interwork an IP-based wide-area DetNet technology with the 5G system to overcome the spatial limitations of the TSN technology.

Similar to the operation of the CNC server 155 when interworking between the 5G system and the TSN described in the example of FIG. 1, in the example of FIG. 2, when the 5G system and the IP network interwork with each other, the DetNet controller 255 may transfer a QoS-related requirement for DetNet interworking the DetNet AF 250 (or TSCTSF/NEF) of the 5G system, and the DetNet AF 250 (or TSCTSF/NEF) may configure necessary information in the device side DetNet translator (DS-DT) 211 on the UE 110 side and the network side DetNet translator (NW-DT) 241 on the network side. The DetNet controller 255 may be implemented as a server (e.g., a DetNet server) of an external network connected to the 5G system. Conversely, the DetNet AF 250 (or TSCTSF/NEF) may collect 5G information from the DS-DT 211 and the NW-DT 241 and transfer the collected information to the DetNet controller 255.

For example, when the 5G system provides time synchronization to the UE 110, the DetNet AF 250 (or TSCTSF/NEF) in the 5G system may configure the NW-DT 241 and the DS-DT 211 based on the QoS-related requirement information provided from the DetNet controller 255, convert the sync message provided from the external network based on the internal time of the 5G system and transfer the sync message, and when a sync message is again transferred from the 5G system to the external network, 5G system may again convert the sync message based on the external time of the external DetNet node 260. In the example of FIG. 2, the sync message converted by the DS-DT 211 may be transferred to a device (DetNet node) tethered to the UE 110 through, e.g., WI-FI.

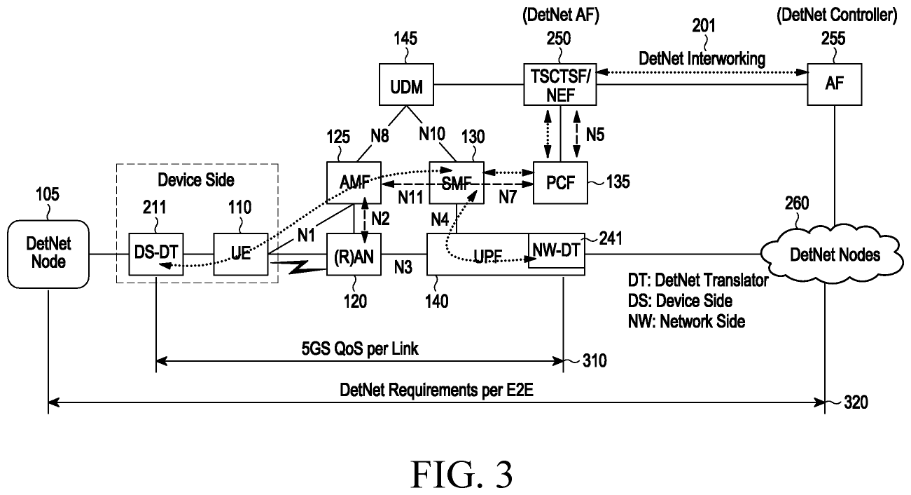

FIG. 3 illustrates requirements upon DetNet interworking when a DetNet provides QoS-related E2E requirements and a 5G system provides QoS-related per-link requirements according to an embodiment of the present disclosure.

In the example of FIG. 1, since the CNC server 155 of the TSN is based on Ethernet, a QoS-related per-link requirement may be derived and provided to the 5G system. However, in the example of FIG. 2, the DetNet controller 255 of DetNet may provide QoS-related E2E requirements. In contrast, the 5G system provides per-link QoS. When interworking with the TSN, the information provided by the CNC server 155 also has per-link requirements, and the 5G system also provides per-link QoS, making information interworking easy. However, since the information provided by the DetNet controller 255 provides the E2E DetNet requirement 320 to the 5G system, the information may not directly interwork with the per-link QoS 310 of the 5G system. A method is required to derive per-link QoS requirements for 5G systems based on DetNet's E2E requirements.

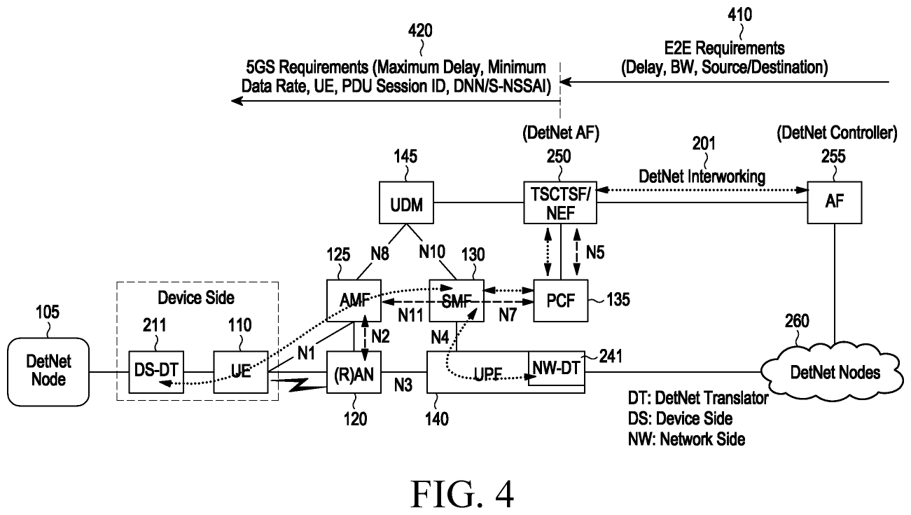

FIG. 4 illustrates a DetNet AF (or TSCTSF/NEF) of a 5G system derives per-link QoS requirements for a 5G system from E2E requirements of a DetNet according to an embodiment.

Referring to FIG. 4, for example, when the DetNet controller 255 provides QoS-related E2E requirements 410 (e.g., delay, BW, source/destination IP information, etc.) to the 5G system, the DetNet AF 250 (or TSCTSF/NEF) of the 5G system may derive QoS-related per-link requirements 420 (e.g., maximum delay, minimum data rate, UE IP, PDU session ID, DNN/S-NSSAI etc.) in the 5G system, based on the E2E requirements 410. The specific methods are 1) to 3) below.
1) The DetNet controller (250) (or TSCTSF/NEF) transfers QoS-related E2E requirements (Src IP, Dst IP, E2E Req (e.g., delay, BW), etc.) to the 5G system. The parameters included in the QoS-related E2E requirements are as follows: A-1 and B-1.
A-1) Src IP, Dst IP: IP address and port information about the source node and IP address and port information about the destination node in the end-to-end flow.
B-1) Maximum delay that may be guaranteed end-to-end (E2E), minimum bandwidth (BW) that may be guaranteed end-to-end.
2) The DetNet AF 250 (or TSCTSF/NEF) of the 5G system converts the QoS-related E2E requirements into the QoS-related per-link requirements (e.g., UE IP, DNN/S-NSSAI, PDU session ID, maximum delay, minimum data rate, etc.) for the 5G system. The parameters included in the QoS-related per-link requirements are A-2) to C-2) below.
A-2) Derive UE IP(s), DNN(s)/S-NSSAJ(s): Discovers/identifies UE IP and data network name (DNN) and network slice information S-NSSAI(s) derived as being capable of providing a corresponding path based on the Src IP and the Dst IP information and routing information.
B-2) Derive PDU session ID(s): Discovers/identifies the PDU session(s) connected to the DNN/S-NSSAI using the UE IP.
C-2) Select PDU session: Selects the optimal PDU session based on C-2-1) to C-2-3) below by comparing the maximum delay and minimum data rate providable per PDU session with the QoS-related E2E requirements.
C-2-1) Provide the minimum PDB(s) that meets the packet delay budgets (PDBs) of PDU session ID(s)<E2E Req. PDB means the maximum delay that meets the E2E requirements (i.e., the PDB is smaller than the E2E Req. (delay)) per PDU session. When there are multiple PDU sessions, the PDB with the minimum delay may be selected from among the multiple PDBs.
C-2-2) Provide the maximum guaranteed bit rate (GBR) that meets minimum data rate(s) of PDU session ID(s)>E2E Req. (BW).
C-2-3) Determine to prioritize the requirements of C-2-1) when the results of C-2-1) and C-2-2) differ from each other.
3) Configure and modify the QoS for the PDU session specified with the PDU session ID: Configures the core network (CN), RAN, and UE to guarantee the maximum delay and minimum data rate configured in step 2) above.

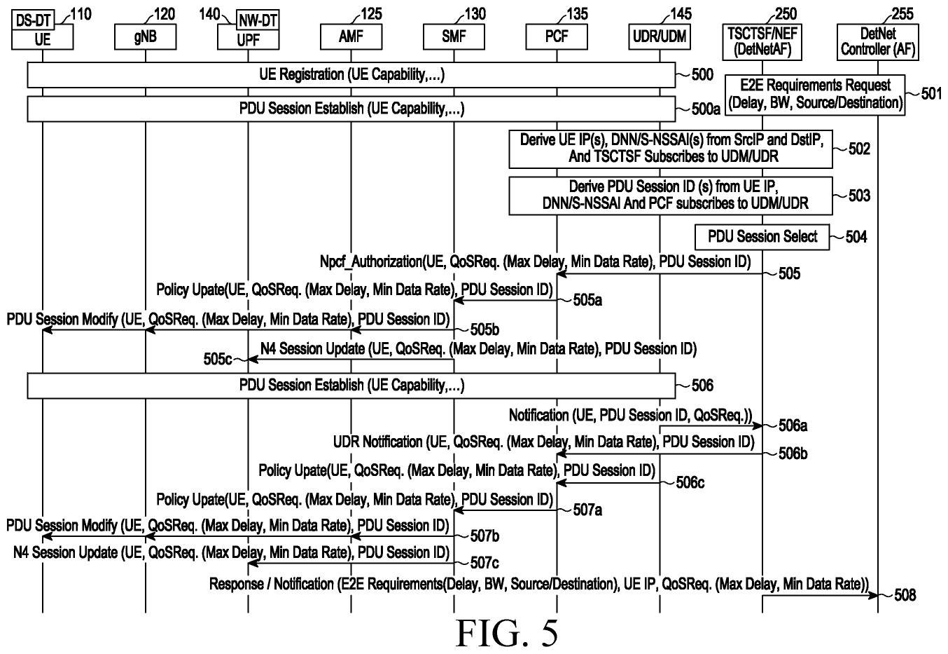

FIG. 5 illustrates a network procedure to which the method of FIG. 4 is applied when a 5G system interworks with a DetNet according to an embodiment of the present disclosure.

In step 500 of FIG. 5, the UE 110 performs a registration procedure in the 5G system. In this case, a registration request message transmitted by the UE 110 to the network may include capability information about the UE 110 indicating whether the UE 110 is operable according to the request of the DetNet. Further, the subscriber information about the UE 110 may include information indicating whether a low-delay service may be provided according to a request from the DetNet.

In step 500a, the UE 110 performs a PDU session establishment procedure in the 5G system. In this case, a PDU session establishment request message transmitted by the UE 110 to the network may include capability information about the UE 110 indicating whether the UE 110 is operable according to the request of the DetNet. Further, the subscriber information about the UE 110 may include information indicating whether a low-delay service may be provided according to a request from the DetNet. For example, the capability information about the UE 110 may be included in at least one of the registration request message and the PDU session establishment request message.

In step 501, the DetNet controller 255 (or external AF) transfers the QoS-related end-to-end (E2E) requirements to the DetNet AF 250 (or TSCTSF/NEF) of the 5G system. The information about the QoS-related E2E requirements may include source IP and port and destination IP and port information as information indicating the end-to-end flow. The information about the E2E requirements may include at least one of the maximum delay to be guaranteed end-to-end and the minimum bandwidth to be guaranteed end-to-end.

In step 502, the DetNet AF 250 (or TSCTSF/NEF) of the 5G system may derive/acquire/generate information about the QoS-related per-link requirements in the 5G system based on the information about the E2E requirements. Specifically, the DetNet AF 250 (or TSCTSF/NEF) may derive the QoS-related per-link requirement information including at least one of UE IP(s) and DNN(s)/S-NSSAI(s) determined to be able to provide the corresponding path, based on source IP/port and destination IP/port information and routing information from the E2E requirement information. Further, the DetNet AF 250 (or TSCTSF/NEF) may subscribe to notify the UDM/UDR 145 of a PDU session meeting the conditions of the QoS-related per-link requirements.

In step 503, the DetNet AF 250 (or TSCTSF/NEF) may derive a PDU session ID(s) matching the UE IP(s) and DNN(s)/S-NSSAI(s) information. Further, the PCF 135 may subscribe to the UDM/UDR 145 to notify when a PDU session meeting the conditions of the QoS-related per-link requirements is generated.

In step 504, the DetNet AF 250 (or TSCTSF/NEF) may select the optimal, at least one PDU session by comparing the maximum delay and minimum data rate, which may be provided per PDU session, with the QoS-related E2E requirements from among the PDU session(s) selected as candidate(s) that meet the QoS-related per-link requirements in step 503. For example, the DetNet AF 250 (or TSCTSF/NEF) may select the PDU session that provides the minimum DPB from among the PDU sessions in which the PDB providable per PDU session is smaller than the E2E delay requirement. Further, the DetNet AF 250 (or TSCTSF/NEF) may select the PDU session that provides the maximum GBR meeting the condition that the minimum data rate provided per PDU session is larger than the E2E bandwidth requirement. When both the delay condition and the bandwidth (BW) condition may be met, and another PDU session is selected, either the delay condition or the bandwidth (BW) condition may be prioritized. For example, the delay condition may be prioritized to be selected.

In step 505, the DetNet AF 250 (or TSCTSF/NEF) requests the PCF to configure a policy related to the QoS per-link requirements. In this case, the policy configuration request may include at least one of UE information and QoS requirements (max delay, min data rate), and PDU session ID. Further, the DetNet AF 250 (or TSCTSF/NEF) may derive the subscription public identifier (SUPI) or subscription concealed identifier (SUCI) which is UE ID information used inside the 5G system based on the UE IP information and use the UE ID information as the UE information.

In step 505a, the PCF 135 requests the SMF 130 to update the QoS-related policy information. In this case, the policy information update request may include at least one of the UE information and QoS requirements (max delay, min data rate), and PDU session ID.

In step 505b, the SMF 130 transfers the PDU session modify request to the UE 110 through the AMF 125. In this case, the PDU session modify request may include at least one of UE information and QoS requirements (max delay, min data rate), and PDU session ID. The QoS parameters of the RAN (gNB) 120 may be updated through the PDU session modify request.

In step 505c, the SMF 130 may configure the user plane QoS of the core network (CN) through an N4 session update request to the UPF 140. In this case, the N4 session update request may include at least one of UE information and QoS requirements (max delay, min data rate), and PDU session ID.

The operations of step 506 to 507c may be performed when there is no PDU session meeting the QoS-related per-link requirements among the candidate PDU sessions and a new PDU session may be discovered in steps 500a to 505. Accordingly, the following operations of steps 506 to 507c may be selectively performed.

In step 506, the UE 110 may perform a PDU session establish procedure for the new PDU session in the 5G system. In this case, the PDU session establish request message transmitted by the corresponding UE 110 to the network may include capability information indicating whether the corresponding UE 110 may operate according to the request of the DetNet. Further, the subscriber information about the UE 110 may include information indicating whether a low-delay service may be provided according to a request from the DetNet.

In step 506a, the UDM/UDR 145 may notify the DetNet AF 250 (or TSCTSF/NEF) that a new PDU session has been established in accordance with the subscription condition in step 502.

In step 506b, the DetNet AF 250 (or TSCTSF/NEF) requests the PCF 135 to configure a policy related to the QoS requirements. In this case, the policy configuration request may include at least one of UE information and QoS requirements (max delay, min data rate), and PDU session ID. The DetNet AF 250 (or TSCTSF/NEF) may derive the SUPI or SUCI which is UE ID information used inside the 5G system based on the UE IP information and use the UE ID information as the UE information.

In step 506c, the UDM/UDR 145 may request the PCF 135 to update the policy according to the subscription condition in step 503. In this case, the policy update request may include at least one of UE information and QoS requirements (max delay, min data rate), and PDU session ID.

In step 507a, the PCF 135 requests the SMF 130 to update the QoS-related policy information. In this case, the policy information update request may include at least one of the UE information and QoS requirements (max delay, min data rate), and PDU session ID.

In step 507b, the SMF 130 transfers the PDU session modify request to the UE 110 through the AMF 125. In this case, the PDU session modify request may include at least one of UE information and QoS requirements (max delay, min data rate), and PDU session ID. The QoS parameters of the RAN (gNB) 120 may be updated through the PDU session modify request.

In step 507c, the SMF 130 may configure the user plane QoS of the CN through an N4 session update request to the UPF 140. In this case, the N4 session update request may include at least one of UE information and QoS requirements (max delay, min data Rate), and PDU session ID.

In step 508, the DetNet AF 250 (or TSCTSF/NEF) transfers, to the DetNet controller 255 (or external AF), a response to the request in step 501 or a notification for the results performed after steps 506 and 506a. In this case, the response or notification may include at least one of E2E requirements (delay, BW, source/destination info) and the UE IP and QoS requirements (max delay, min data rate).

In the above-described embodiments, the DetNet AF 250 (or TSCTSF/NEF) and the DetNet controller 255 (or external AF) may exist as distinct network entities or may be included in one network entity.

According to the above-described embodiments, it is possible to provide functions necessary for the 5G system by providing the QoS-related end-to-end (E2E) requirements provided by DetNet to the 5G system and converting the QoS-related end-to-end (E2E) requirements into QoS-related per-link requirements in the 5G system when interworking with the IP-based wide-area delay deterministic network (DetNet) technology to provide a delay guarantee service in the 5G system

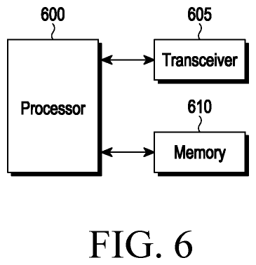

FIG. 6 illustrates a configuration of a network entity in a wireless communication system according to an embodiment of the present disclosure. The network entity of FIG. 6 may be one of such network entities as the DetNet controller, DetNet AF, AF, TSCTSF, NEF, UDM, PCF, SMF, AMF, UPF, (R)AN, UE, and DetNet node described in connection with the embodiments of FIGS. 1 to 6.

The network entity of FIG. 6 may include a processor 600, a transceiver 605, and a memory 610. The processor 600, transceiver 605, and memory 610 of the network entity may be operated according to the communication methods of the network entity described above in connection with the embodiments of FIGS. 1 to 5. However, the components of the network entity are not limited thereto. For example, the network entity may include more or fewer components than the above-described components. The processor 600, the transceiver 605, and the memory 610 may be implemented in the form of a single chip.

The transceiver 605 collectively refers to the receiver of the network entity and the transmitter of the network entity and may transmit and receive signals to/from a UE or another network entity. The transmitted/received signals may include at least one of control information and data. To that end, the transceiver 605 may include a wired/wireless transceiver and may include various components for transmitting/receiving signals. The transceiver 605 may receive signals through a predetermined communication interface, output the signals to the processor 600, and transmit the signals output from the processor 600. Further, the transceiver 605 may receive the communication signal and output it to the processor 600 and transmit the signal output from the processor 600 to the UE or another network entity through the network. The memory 610 may store programs and data necessary for the operation of the network entity according to at least one of the embodiments of FIGS. 1 to 5. Further, the memory 610 may store control information or data that is included in the signal obtained by the network entity. The memory 1005 may include a storage medium, such as ROM, RAM, hard disk, CD-ROM, and DVD, or a combination of storage media. Further, the processor 1001 may control a series of processes so that the network entity may operate according to at least one of the embodiments of FIGS. 1 to 5.

For example, for deterministic network (DetNet) interworking in the wireless communication system, the processor 600 may receive information about a QoS-related end-to-end requirement from an IP-based DetNet server (i.e., the DetNet controller 255) (or an external AF) through the transceiver 605, obtain information about a QoS-related per-link requirement in the wireless communication system based on the information about the QoS-related end-to-end requirement, and select at least one PDU session that meets the QoS-related per-link requirement. The processor 600 may include at least one processor.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or the programs may be stored in a memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments via an external port. A separate storage device over the communication network may be connected to the device that performs embodiments.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present disclosure have been described above, various changes may be made thereto without departing from the scope of the present disclosure. Thus, the scope of the disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network entity supporting deterministic networking (Detnet) in a wireless communication system, the method comprising:
receiving, from a Detnet controller of a deterministic network, configuration information including requirements in the deterministic network;
identifying, based on the configuration information, a protocol data unit (PDU) session associated with an internet protocol (IP) address of a user equipment (UE); and
transmitting, to a policy control function (PCF), quality of service (QoS) parameters obtained based on the requirements in the configuration information, the QoS parameters being used for a policy update to be applied for the PDU session.

2. The method of claim 1, wherein the QoS parameters includes at least one of a maximum latency or a minimum bandwidth to be guaranteed.

3. The method of claim 1, wherein the requirements in the configuration information are to support interworking between the wireless communication system and the deterministic network, and
wherein the network entity includes a time sensitive communications and time synchronization function (TSCTSF) for DetNet interworking.

4. The method of claim 1, further comprising transmitting, to the Detnet controller, a response message in response to reception of the configuration information.

5. The method of claim 1, wherein transmitting, to the PCF, QoS parameters comprises:
transmitting, to the PCF, a message including the QoS parameters and at least one of the IP address of the UE, a data network name (DNN), or single-network slice selection assistance information (S-NSSAI) associated with the PDU session.

6. A network entity supporting deterministic networking (DetNet) in a wireless communication system, the network entity comprising:
a transceiver; and
a processor configured to:
receive, via the transceiver from a Detnet controller of a deterministic network, configuration information including requirements in the deterministic network,
identify, based on the configuration information, a protocol data unit (PDU) session of associated with an internet protocol (IP) address of a user equipment (UE), and
transmit, to a policy control function (PCF) via the transceiver, a message including quality of service (QoS) parameters obtained based on the requirements in the configuration information, the QoS parameters being used for a policy update to be applied for the PDU session.

7. The network entity of claim 6, wherein the QoS parameters includes at least one of a maximum latency or a minimum bandwidth to be guaranteed.

8. The network entity of claim 6, wherein the requirements in the configuration information are to support interworking between the wireless communication system and the deterministic network, and
wherein the network entity includes a time sensitive communications and time synchronization function (TSCTSF) supporting Detnet interworking.

9. The network entity of claim 6, wherein the processor is further configured to transmit, to the Detnet controller via the transceiver, a response message in response to reception of the configuration information.

10. The network entity of claim 6, wherein the processor is further configured to:
transmit, to the PCF, a message including the QoS parameters and at least one of the IP address of the UE, a data network name (DNN), or single-network slice selection assistance information (S-NSSAI) associated with the PDU session.

11. A deterministic networking (Detnet) controller of a deterministic network communicating with a network entity supporting DetNet in a wireless communication system, the Detnet controller comprising:
a transceiver; and
a processor configured to:
transmit, to the network entity via the transceiver, configuration information including quality of requirements in the deterministic network, and
receive, via the transceiver from the network entity, a response message in response to transmission of the configuration information,
wherein a protocol data unit (PDU) session associated with an internet protocol (IP) address of a user equipment (UE) is identified based on the configuration information, and
wherein quality of service (QoS) parameters, based on the requirements in the configuration information, are used for a policy update to be applied for the PDU session.

12. The Detnet controller of claim 11, wherein the QoS parameters includes at least one of a maximum latency or a minimum bandwidth to be guaranteed.

13. The Detnet controller of claim 11, wherein the requirements in the configuration information are to support interworking between the wireless communication system and the deterministic network.

14. The Detnet controller of claim 11, wherein the network entity includes a time sensitive communications and time synchronization function (TSCTSF) for Detnet interworking.

15. The Detnet controller of claim 11, wherein at least one of the IP address of the UE, a data network name (DNN), or single-network slice selection assistance information (S-NSSAI) associated with the PDU session is identified based on the configuration information.

16. A policy control function (PCF) in a wireless communication system, the PCF comprising:
a transceiver; and
a processor configured to:
receive, from a network entity supporting deterministic networking (Detnet), quality of service (QoS) parameters corresponding to requirements in a deterministic network, and
update, based on the QoS parameters, a policy to be applied for a protocol data unit (PDU) session associated with an internet protocol (IP) address of a user equipment (UE).

17. The PCF of claim 16, wherein the QoS parameters includes at least one of a maximum latency or a minimum bandwidth to be guaranteed.

18. The PCF of claim 16, wherein the requirements in the deterministic network are to support interworking between the wireless communication system and the deterministic network, and
wherein the network entity includes a time sensitive communications and time synchronization function (TSCTSF) for Detnet interworking.

19. The PCF of claim 16, wherein the requirements in the deterministic network is included in configuration information provided from a Detnet controller of the deterministic network.

20. The PCF of claim 16, wherein the processor is further configured to transmit, to a session management function (SMF) managing the PDU session, information on the updated policy.
